(19) United States
(12) Patent Application Publication
(10) Pub. No.: US 2014/0259005 A1
(43) Pub. Date: Sep. 11, 2014

(54) SYSTEMS AND METHODS FOR MANAGING FILES IN A CLOUD-BASED COMPUTING ENVIRONMENT

(71) Applicant: Air Computing, Inc., Palo Alto, CA (US)

(72) Inventors: Mark Christopher Jeffrey, Palo Alto, CA (US); Weihan Wang, Palo Alto, CA (US)

(73) Assignee: Air Computing, Inc., Palo Alto, CA (US)

(21) Appl. No.: 14/201,678

(22) Filed: Mar. 7, 2014

Related U.S. Application Data
(60) Provisional application No. 61/775,351, filed on Mar. 8, 2013.

(51) Int. Cl. H04L 29/08; G06F 9/445

(52) U.S. Cl. CPC H04L 67/104; G06F 8/65
USPC 717/173

(57) ABSTRACT

In one embodiment, a method for collecting updates for a plurality of objects over a cloud data network includes: determining a set of remote devices known to have updates for a selected object, wherein each of said remote devices maintains a set of locally updated objects that includes the selected object; and downloading the updates for the selected object from said set of remote devices. Where said downloading the updates for the selected object results in a name conflict, the method further includes resolving said name conflict, wherein said resolving includes selecting said selected object as a target and said existing object as an alias having a pointer relationship to the target; and merging all meta-data of the alias object into the target.

### RELATED APPLICATION

The present application claims priority to U.S. Provisional Patent Application Ser. No. 61/775,351, filed Mar. 8, 2013, which is incorporated by reference herein in its entirety for all purposes.

### FIELD OF THE INVENTION

Embodiments are directed to systems and methods for managing content in a cloud-based storage, and more specifically, to systems and methods for efficient file sharing among devices in a peer-to-peer configuration.

### BACKGROUND

File sharing is the practice of distributing or providing access to digitally stored information, such as computer programs, multimedia (audio, images, and video), documents, or electronic books. It may be implemented through a variety of ways. Storage, transmission, and distribution models are common methods of file sharing that incorporate manual sharing using removable media, centralized computer file server installations on computer networks, World Wide Web-based hyperlinked documents, and the use of distributed peer-to-peer networking.

Peer-to-peer file sharing is the distribution and sharing of digital documents and computer files between users (or peers/nodes) in a peer-to-peer network. Users are able to access/exchange one or more files from one computer to another across a network (e.g., the Internet) by simply searching and linking to another computer with the requested file. Increased Internet bandwidth, the widespread digitization of physical media, and the increasing capabilities of residential personal computers have contributed to the extensive adoption of peer-to-peer file sharing. Even further, cloud computing—a distributed network of computers connected through a real-time communication network (e.g., the Internet)—provides convenience and accessibility for file sharing to an almost unlimited number of computer files and resources.

However, as the number of digital documents, computer files, and users increase, cloud-file sharing becomes susceptible to issues involving data protection, security management, identity access, and efficiency. Accordingly, a need exists for improved systems and methods for efficient file sharing among devices in a peer-to-peer configuration to overcome the aforementioned obstacles and deficiencies of prior art systems.

### SUMMARY

In one embodiment, a method for cloud file management includes registering a first user and a first device with a server, creating a library for object storage, transmitting an invitation to access the library to a second user, the second user having a second device, verifying and granting the second user access to the library, wherein granting the second user access to the library comprises granting the second device access to the library. An object having a replication factor and two or more components is stored on one or more of the first device and the second device according to the replication factor and total storage available on the first device and the second device.

In an alternative embodiment, the method for cloud file management further comprises optimizing network queries to download a file from the library; resolving a conflict of logical identifiers for the file; updating the file via propagation of object updates; resolving concurrent updates to files on the first device and the second device; maintaining a version history for the file; and presenting the sync status of every file and folder.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 illustrates an exemplary computer architecture for use with the present system, according to one embodiment.

FIG. 2 illustrates an exemplary architecture of the present system, according to one embodiment.

FIG. 3 illustrates a device architecture for use with the present system, according to one embodiment.

FIG. 4 illustrates an exemplary version table for use with the present system, according to one embodiment.

FIG. 5 illustrates an exemplary operation on a collector queue and on a collector set for use with the present system, according to one embodiment.

FIG. 6 illustrates an exemplary name conflict to be resolved by the present system, wherein a concurrent creation of a physical object generates two logical object identifiers for the same path, according to one embodiment.

FIG. 7A illustrates an exemplary state transition diagram for resolving the name conflict with two disjoint object identifiers, such as the name conflict illustrated in FIG. 6, according to one embodiment;

FIG. 7B illustrates an exemplary state transition diagram for resolving the name conflict with three disjoint object identifiers, according to one embodiment;

FIG. 7C illustrates an exemplary state transition diagram for resolving the name conflict with four disjoint object identifiers, according to one embodiment.

FIG. 8A illustrates an exemplary initial installation process for use with the present system, according to one embodiment.

FIG. 8B illustrates an exemplary subsequent installation process for use with the present system, according to one embodiment.

FIG. 9 illustrates an exemplary access control list for user with the present system, according to one embodiment.

FIG. 10 illustrates an exemplary library management process for use with the present system, according to one embodiment.

FIG. 11 illustrates an exemplary tree representation of a logical directory undergoing an expulsion of a file and folder, according to one embodiment.

FIG. 12A illustrates an exemplary migration of an object between stores for devices subscribing to a different set of stores, according to one embodiment;

FIG. 12B illustrates an exemplary update to the content of the object being migrated between stores in FIG. 12A, according to one embodiment; and

FIG. 12C illustrates an exemplary logical state change for the migration illustrated in FIGS. 12A-B, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings disclosed herein and do not limit the scope of the claims.

### DETAILED DESCRIPTION OF PREFERRED EMBODIMENTS

The language used to disclose various embodiments describes, but should not limit, the scope of the claims. For example, in the following description, for purposes of clarity and conciseness of the description, not all of the numerous components shown in the schematic are described. The numerous components are shown in the drawings to provide a person of ordinary skill in the art a thorough enabling disclosure of the present invention. The operation of many of the components would be understood and apparent to one skilled in the art. Similarly, the reader is to understand that the specific ordering and combination of process actions described is merely illustrative, and the disclosure may be performed using different or additional process actions, or a different combination of process actions.

Each of the additional features and teachings disclosed herein can be utilized separately or in conjunction with other features and teachings to provide cloud file management. Representative examples using many of these additional features and teachings, both separately and in combination, are described in further detail with reference to the attached drawings. This detailed description is merely intended for illustration purposes to teach a person of skill in the art further details for practicing preferred aspects of the present teachings and is not intended to limit the scope of the claims. Therefore, combinations of features disclosed in the detailed description may not be necessary to practice the teachings in the broadest sense, and are instead taught merely to describe particularly representative examples of the present disclosure. Additionally and obviously, features may be added or subtracted as desired without departing from the broader spirit and scope of the disclosure. Accordingly, the disclosure is not to be restricted except in light of the attached claims and their equivalents.

Computer Architecture

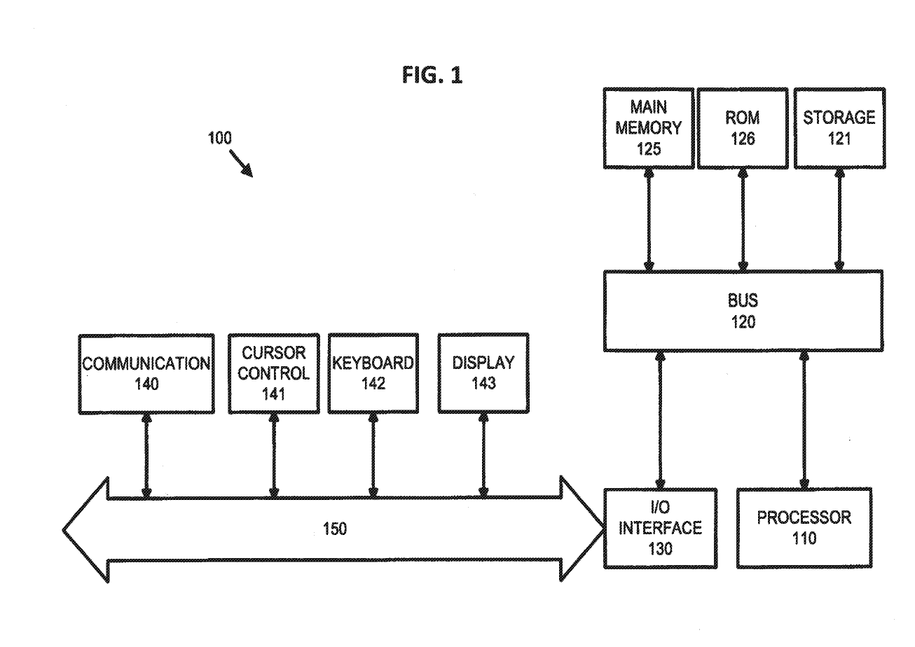

FIG. 1 illustrates an exemplary computer architecture for use with the present system, according to one embodiment. One embodiment of architecture 100 comprises a system bus 120 for communicating information, and a processor 110 coupled to bus 120 for processing information. Architecture 100 further comprises a random access memory (RAM) or other dynamic storage device 125 (referred to herein as main memory), coupled to bus 120 for storing information and instructions to be executed by processor 110. Main memory 125 also may be used for storing temporary variables or other intermediate information during execution of instructions by processor 110. Architecture 100 also may include a read only memory (ROM) and/or other static storage device 126 coupled to bus 120 for storing static information and instructions used by processor 110.

A data storage device 127 such as a magnetic disk or optical disc and its corresponding drive may also be coupled to computer system 100 for storing information and instructions. Architecture 100 can also be coupled to a second I/O bus 150 via an I/O interface 130. A plurality of I/O devices may be coupled to I/O bus 150, including a display device 143, an input device (e.g., an alphanumeric input device 142 and/or a cursor control device 141).

The communication device 140 allows for access to other computers (servers or clients) via a network. The communication device 140 may comprise one or more modems, network interface cards, wireless network interfaces or other well known interface devices, such as those used for coupling to Ethernet, token ring, or other types of networks.

System Architecture

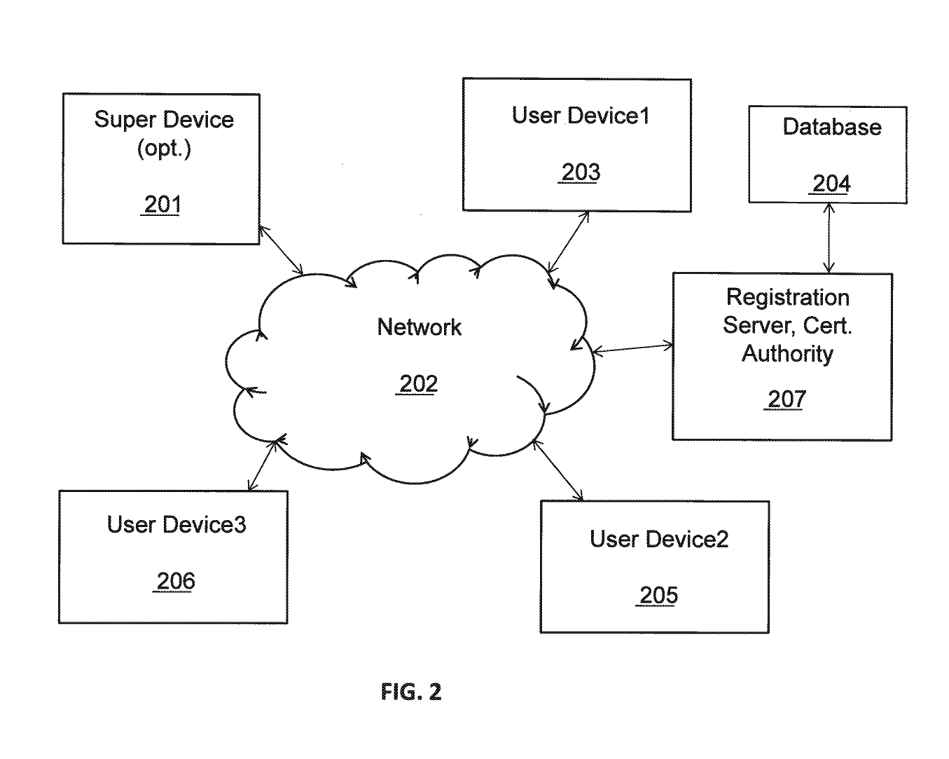

FIG. 2 illustrates an exemplary architecture of the present system, according to one embodiment. Multiple devices 201, 203, 205, 206 communicate over a network 202. The network 202 (also referred to herein as an overlay network) enables direct communication between any two peers/devices even if the peers/devices have dynamic IP addresses, are behind firewalls, or if the peers cannot directly send IP packets to each other for any other reason.

Devices 201, 203, 205, 206 can be a user's own devices or servers provided by third-party service providers. Servers can be from different providers to ensure high availability or other reasons. Devices 201, 203, 205, 206 can be automatically or manually appointed as super devices (e.g., device 201). Super devices (201) are identical to other devices except that they are more active and aggressive in data synchronization, and perform more tasks such as helping other devices establish network 202 connections and propagate updates.

A registration server 207 (optionally in communication with a database 204) ensures global uniqueness of various types of identifiers. It is used in conjunction with a certificate authority (CA) to register identifiers and to issue certificates binding the identifiers with appropriate public keys. Communication between devices 201, 203, 205, 206 is purely peer-to-peer, without involving either of the two servers (registration and CA) 207. Devices 201, 203, 205, 206 refer to the servers 207 only when registering or looking up new identifiers, or updating Certificate Revocation Lists (CRL).

As used herein, files and folders are referred to as objects. Objects are identified by globally unique object IDs (e.g., 128-bit UUID). According to one embodiment, an object ID is a type 4 (pseudo randomly generated) UUID and paths are part of an object's metadata. Libraries (also referenced herein as stores) are special folders, which a specified group of users (e.g., via devices 201, 203, 205, 206) can share and collaborate on the folders' contents (i.e., objects). Libraries are identified by library addresses, which are globally unique strings of arbitrary lengths. Users are identified by user IDs which are also globally unique strings of arbitrary lengths. According to one embodiment, user IDs are email addresses. A device ID is the device owner's user ID combined with a 32-bit integer value. The integer value is unique in the scope of the user ID. In one embodiment, the device ID never changes during a device's life cycle.

The central registration server 207 guarantees the uniqueness of the identifiers (e.g., object IDs, library addresses, user IDs, device IDs, and so on). Devices 201, 203, 205, 206 generate IDs and register them with the registration server 207. A device (e.g., devices 201, 203, 205, 206) must re-generate a new ID if the server 207 finds the ID is already registered and returns an error to the device.

According to one embodiment, a public/private key pair is associated with each user. Key pairs are generated with an algorithm (one such example is RSA/ECB/PKCS1 Padding, other algorithms may be used). According to one embodiment, public keys are encoded according to standards for a public key infrastructure (PKI) and Privilege Management Infrastructure (PMI) (e.g., in X.509 format), and private keys are PKCS#3 encoded. According to one embodiment, a Java® virtual machine default security provider is used for key generation and other security-related tasks.

Public keys are certified by a Certificate Authority (CA) (e.g., the registration server 207). Users may choose to use any CA they trust. Certificate verification is part of the authentication process. Devices periodically update root certificates and Certificates Revocation Lists. Such information may be saved in libraries and is automatically synchronized with other contributing devices.

According to one embodiment, several hard drives or other media on a device can be used at the same time. For example, if a user adds two drives on a selected device with 100 GB each, 200 GB of data can be stored on the selected device. In addition, the user may designate a quota for each drive by specifying either an absolute capacity or the percentage relative to the capacity of the drive, or relative to the free space on the drive.

Device Architecture

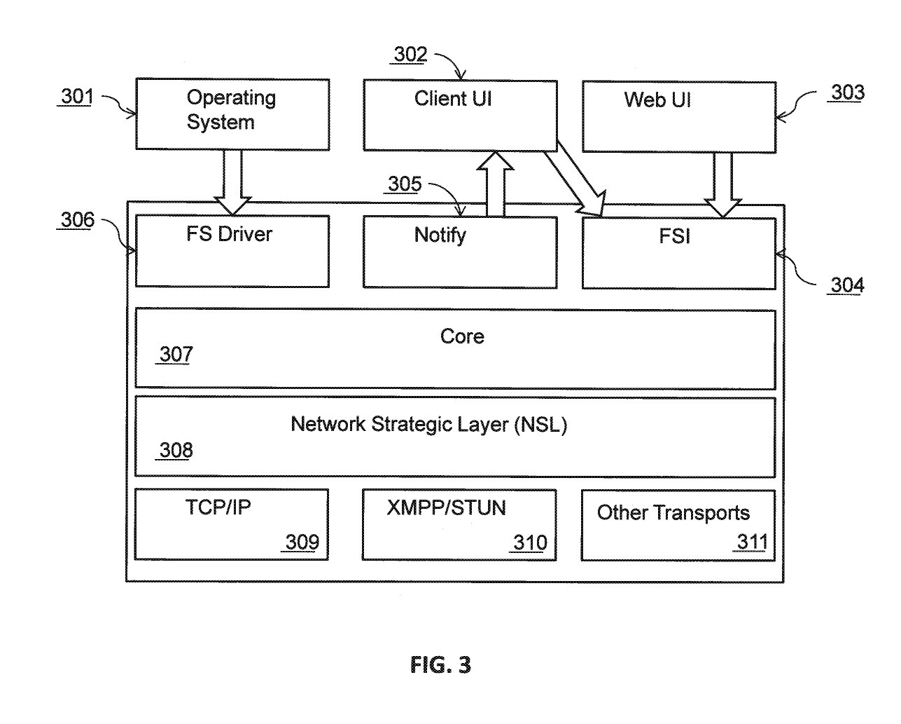

FIG. 3 illustrates a device architecture for use with the present system (e.g., devices 201, 203, 205, 206), according to one embodiment. A daemon (illustrated as 304-311 in FIG. 3) performs core logic including data management, communicating with other devices, and serving file system requests. An interface (illustrated as 301-303 in FIG. 3) exposes functions to the user through appropriate user interfaces. The daemon and interface run in different processes, communicating through Remote Procedure Calls (RPC, shown as arrows in FIG. 3).

An operating system 301 forwards file system requests (e.g., file read/write) from a requesting application to the daemon (at a file system (FS) driver 306), and passes results back to the requesting application. A client user interface (UI) 302 exposes functions such as user and device management. These functions are beyond typical file system operations. A web UI 303 allows the user to access library data remotely through a Web browser. The web UI 303 is typically present on cloud servers that provide a Web interface for data access.

The FS driver 306 exposes a locally mounted file system. On Microsoft Windows®, for example, the FS driver 306 presents a file system drive with a drive letter (e.g., Z:\).

A FSI (file system interface) 304 exposes application programming interface (API) calls to the client UI 302 and web UI 303. These API calls are a super set of typical file system operations. A notify interface 305 is the interface through which the daemon notifies various events such as file changes to the processes that have subscribed for the events. This notification mechanism is mainly used to refresh user interfaces.

The core 307 performs core logic including data management and synchronization. The core 307 runs on top of an overlay network, and is agnostic on the actual network technologies on which the overlay network operates (e.g., TCP, XMPP, etc). The modules under the core 307, i.e., a network strategic layer (NSL) 308 and transport modules 309, 310, 311, implement the overlay network. The NSL 308 and transport modules 309, 310, 311, together, enable the local device to communicate directly with any other devices over any networks of arbitrary topologies.

Transport modules include TCP/IP 309, XMPP/STUN 310, and other transports 311. Each transport (i.e., TCP/IP 309, XMPP/STUN 310, other transports 311) supports a single network transport technology. Multiple transports work together to provide maximum connectivity as well as best performance.

Consider the following example: When two devices are within the same Local Area Network (LAN), they may be directly connected using TCP or UDP. The TCP/IP module 309 will detect this situation and connect the two devices. However, if the two devices are behind their own firewalls, TCP/IP transport will fail. Meanwhile, the XMPP/STUN module 310 is able to connect the peers using an intermediate XMPP server and the STUN protocol.

The network strategic layer (NSL) 308 ranks transports when more than one transport is available to connect to a remote device. The NSL 308 selects the best transport based on various transport characteristics and network metrics. In the previous example, if the two peers are within the same LAN, both TCP/IP 309 and XMPP/STUN 310 modules are able to connect them. When sending messages between the peers, the NSL 308 is likely to select the TCP/IP module 309 as the preferred transport as it can provide lower latency and higher throughput.

The overlay networking layer, implemented by the NSL 308 and transport modules 309-311, is exposed to the core 307 via a programming interface. The core 307 uses this interface to communicate with other peers on the overlay network without knowing actual transport implementations. The interface defines common network protocol primitives must be supported by the transports. Examples of network protocol primitives include the following:

Atomic message: Atomic messages are like datagram packets. They may be delivered out of order and may be dropped silently. There is no flow control for atomic messages. Each transport suggests to the core a maximum atomic message size they can handle, and is free to drop messages that are too large. Partial delivery is not accepted. The entire message is either fully delivered or fully dropped. There are three types of atomic messages: unicast, maxcast, and wildcast.
Unicast atomic message: The destination of a unicast atomic message is always a particular device identified by the device id.
Maxcast atomic message: a maxcast atomic message is destined to all the devices contributed to a specified library. It is similar to conventional multicast which sends packets to a group of devices. However, maxcast significantly differs in that it allows the implementing transport deliver the message to an arbitrary number (including zero) of destination devices, although it is encouraged to deliver to as many devices as possible with best efforts. Maxcast is useful to many network applications that require wide-area multicast. Reliable multicast across the Internet, however, is too expensive to be practical. Maxcast suggests an alternative approach for network applications where the application is aware of and capable to handle unreliability in an application specific way.
Wildcast atomic message: a wild atomic message is destined to all the devices the local device can reach. Similar to maxcast, wildcast does not require reliable delivery.

Stream: a stream is a data flow destined to a specified remote device. Unlike atomic messages, streams require in-order and flow-controlled delivery of data in a stream. Any delivery failure shall be reported to the core 307. There may be multiple concurrent, interweaving streams from one device to another. Data from different streams may be delivered out of order.

Synchronization and Consistency

An update to an object includes, but is not limited to, the creation, deletion, modification, or renaming of the object. Devices contributing to/updating a library continually perform pair-wise information exchange to synchronize objects in that library. Because any device may be disconnected at any time, the optimistic replication is enabled. That is, an object is not guaranteed to be synchronized across all the devices at all times. Instead, a device is allowed to update an object even if it is disconnected. Updates are opportunistically propagated to other devices. As a result, two or more devices can update an object at the same time. Such update conflicts are allowed and are resolved either automatically or manually when detected at a later time.

According to one embodiment, eventual consistency is provided by the present system. That is, no assumption is made as to how long it takes for an update to reach from one device to another or when two devices get synchronized (i.e., each device has all the updates known by the other). Multiple techniques are provided for herein to expedite update propagation with best effort, and that allow end users to forcibly synchronize one device from the other. After the update process, the former device is guaranteed to have all the updates known by the latter.

Not all contributing devices are required to store all data contained within a library. Redundant data is removed and the degree of replication is reduced if device space is full. This is useful when the device space is constrained, or the user wants to integrate the capacity of several devices into a bigger storage pool.

Consider the following example: suppose a library is contributed to by two devices with 100 GB storage each. If the total amount of data in the library is 100 GB or less, every byte will be replicated on both devices. However, if there is 120 GB worth of data, only 80 GB will be replicated. The remaining 40 GB has only one copy residing on either device. When there is 200 GB worth of data, no data can be replicated. However, the capacity is maximized in this case.

According to one embodiment, which set of data is to be replicated or evicted is chosen based on heuristics of usage patterns. For example, data that has not been accessed for a long time can be evicted. The replicated and evicted datasets on each device are adjusted dynamically based on runtime measurements. An algorithm is used to guarantee any piece of data has at least N copies throughout the system where N is a user specified number with the minimum value of 1. This number is 1 in the above example.

According to one embodiment, a user can pin objects to a particular device. Pinned objects are never evicted from the device even if the device is full. The maximum capacity of a library is reduced as a result.

In any case, the user sees the same dataset containing all the objects on any devices, even though some objects do not physically reside on the device. When the user requests to open one of these objects, the system will attempt to download the object from other devices while opening the objects—i.e., streaming. Streaming may fail if there is not available device to stream the data from.

Update Propagation: Components and Component Handler Plug-Ins

Updates are defined in a sub-object unit referred to as components. Each file has two or more components. Component one is defined as metadata component, referring to all the fields of the file's metadata; component two is defined as content component, referring to the entire content of the file. Application developers can arbitrarily define component three and above. Each folder has one or more components. Component one includes metadata components. Component two and beyond are determined by application developers. When updating an object, a component number is associated with the update. If the application does not provide a component number, default numbers are used. For example, because applications cannot associate component numbers for updates through the local file system interface, these updates are assigned default numbers.

The combination of an object id and a component number is a component id. A component id uniquely identifies a component.

Using components rather than objects as update units allows updates to be propagated in a finer granularity than sending the entire objects. This is helpful for applications that manage large files such as databases and media editing tools. For example, suppose a calendar application uses a single file to store all calendar entries. The developer may assign each calendar entry with a component number, and pass the number to the present device whenever updating an entry. Therefore, when an entry is updated, only the data of the entry, rather than the entire file content, needs to be transmitted over the network. However, applications register component handler plug-ins that map a given component number to its corresponding data in an application specific way.

Update Propagation: Epidemic Update Propagation

According to one embodiment, epidemic algorithms propagate updates. In particular, each device periodically polls for updates from a random online device which contributes to the same library. In order to speed up propagation for new updates, whenever an update is made on a device, the device pushes the update to other devices using maxcast atomic messages. The message contains the version of the update and optionally the update itself if the size of the update is insignificant. In the actual implementation, several updates are aggregate into one message. A more detailed description of epidemic algorithms is provided in Demers, A., et al. “Epidemic algorithms for replicated database maintenance.” Proceedings of the Sixth Annual ACM Symposium on Principles of Distributed Computing (Vancouver, British Columbia, Canada, Aug. 10-12, 1987). F. B. Schneider, Ed. PODC '87. ACM, New York, N.Y., 1-12, which is fully incorporated herein by reference.

Whereas push is used to expedite update propagation, pull is to ensure no update is missing by a device, which is required by eventual consistency. Supporting both push and pull requires novel design on concurrency control algorithms, which is described below. More sophisticated epidemic algorithms such as gossiping can be used to further optimize update propagation.

In either push or pull, a device may propagate updates originated from other devices. Therefore, the system does not assume the source of an update.

Update Propagation: Concurrency Control

According to one embodiment, classic version vectors are used to track causal relations of updates. Version vectors are a data structure used in optimistic replication systems and includes a mapping of device ids to integer version counts per id. The form {A1, B2, C5} denotes a version vector, where A, B and C are device ids and 1, 2, and 5 are their respective version numbers. A more detailed description of version vectors is provided in Parker et al., “Detection of Mutual Inconsistency in Distributed Systems,” IEEE Transactions on Software Engineering, Vol. SE-9, No. 3, May 1983, pp. 240-247, which is fully incorporated herein by reference.

For example, on device A, the current version vector of a component is {A1, B2, C5}. When A updates the component, it needs to increment the version number corresponding to its own device id by one. Therefore, a new version vector of the component will become {A2, B2, C5} after the update. Device A then propagates the update along with the new version to other devices.

Version Tables

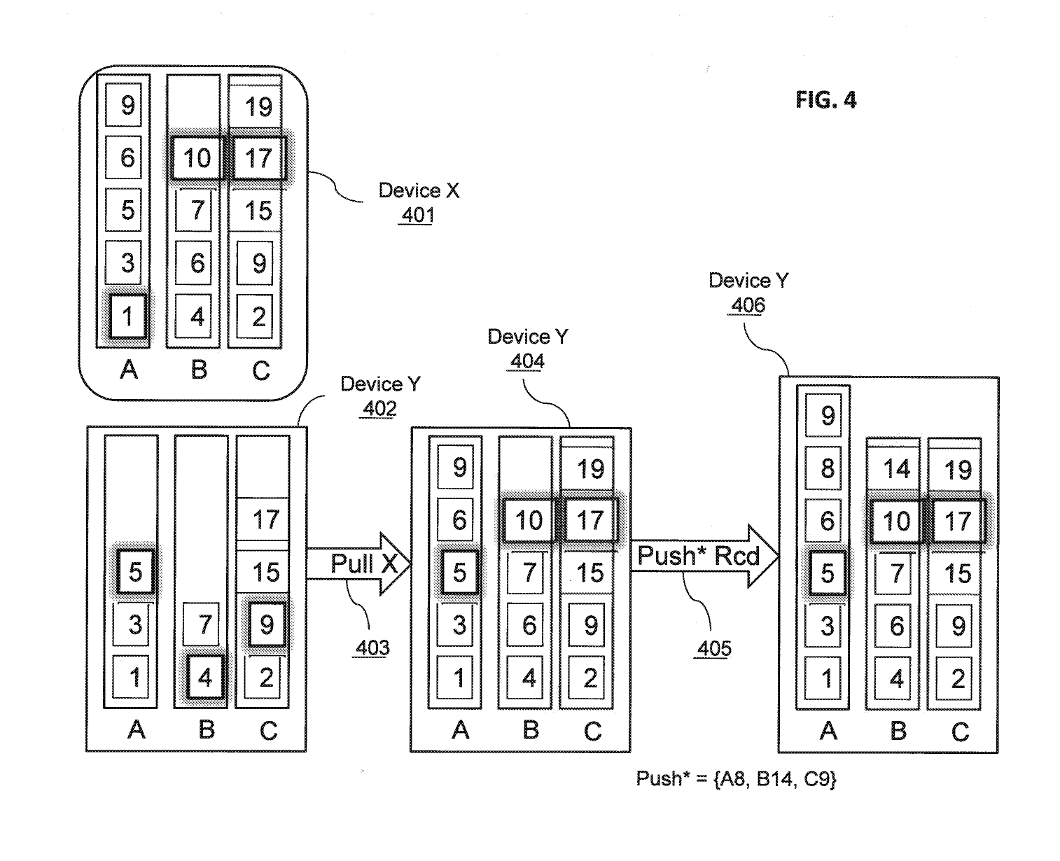

FIG. 4 illustrates an exemplary version table for use with the present system, according to one embodiment. Two devices, device X 401 and device Y 402 have version tables. To maintain version vectors, each device remembers the version it has received so far in a database-table-like data structure, a version table. Each row of the table consists of three tuples: a component id, a device id, and a version number. The table is indexed by device ids and sorted by version numbers. Each rectangle in FIG. 4 represents a row in the table with device ids and component ids omitted. Rectangles with the same device id are placed in one sorted column denoted by the device id.

There is a version vector associated with each device, a knowledge vector. Knowledge vectors are used to determine “stableness” of version numbers. The knowledge vector is initially empty. In FIG. 4, device X's 401 knowledge vector is {A1, B10, C17}.

Pull-based propagation maintains version tables as follows: when a device Y 402 pulls 403 from device X 401, device Y 402 sends its knowledge vector ({A5, B4, C9} in FIG. 4) to a device X 401. Device X 401 then replies with all the version numbers that are “greater than” device X's 401 knowledge vector to device Y 402. The device ids and component ids associated with these version numbers are also transmitted. In the example illustrated in FIG. 4, the numbers being replied are A6, A9, B10, C15, C17, and C19. Upon receiving these numbers, device Y 404 stacks them into its own version table 404.

In addition, device X 401 also sends its knowledge vector to device Y 404. Y then “merges” this vector with its own knowledge vector: Version numbers in the new vector are the pair-wise maximum between the two input vectors. In the example, device Y's 404 new knowledge vector becomes {A5, B10, C17}.

Whenever a device receives a push-based propagation, it inserts the received version numbers into its table, but makes no change on the knowledge vector.

Stability of Version Numbers

Devices may miss pushed messages because of unreliable networks or simply because the device is offline when the push happens. Therefore, pulls are used to guarantee that a device retrieves all missing updates. A naïve approach of pulling is to fetch all versions the target device has. However, it is inefficient if the amount of version numbers is huge. Therefore, only versions unknown to the pulling device are transferred with the help of knowledge vectors.

Version numbers in device Y's 404 knowledge vector are said to be stable to device Y 404. It can be shown that using the process described in the last section, if a version number n from device X 401 is stable to device Y 404, then any version numbers from device X 401 that are smaller than n are already known (received) to device Y 404.

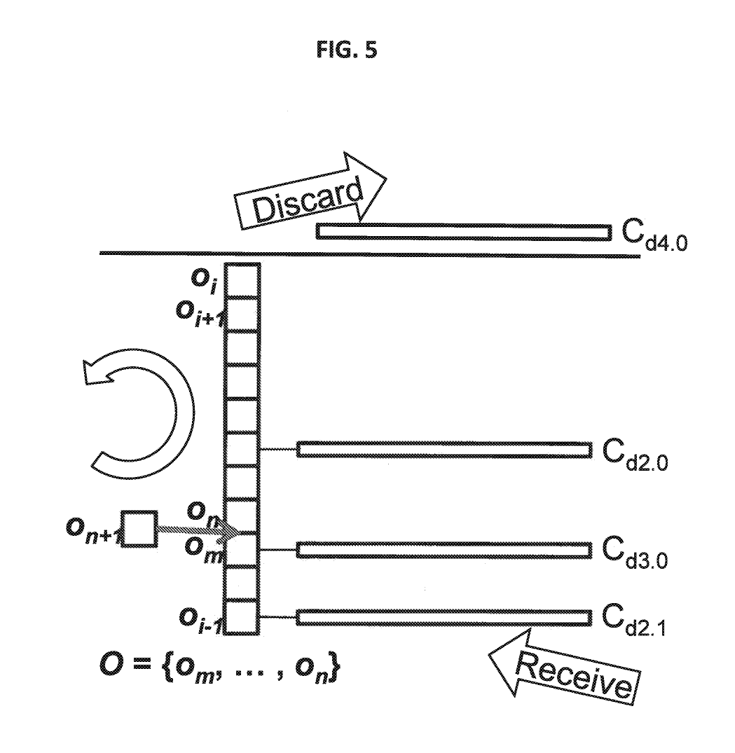

Whenever a device receives a push-based propagation, it inserts the received version numbers into its table, but makes no change on the knowledge vector. FIG. 5 includes an example of a push 405 operation.

Collector: Efficient Selection of Devices to Request File Download

In a peer-to-peer configuration of devices that share a store—through the consistency process discussed above—updates to objects are propagated among devices. In this context, receipt of an update for object with an id o (from the perspective of a local device) signifies that the device now has knowledge that some update (e.g., modification, creation, renaming, or deletion) of o occurred on some other device in the network. Given this update knowledge, and assuming the local device knows all those devices (e.g., peers) that also are online, how can the local device choose from which of its online peers to download that update?

In one embodiment, a collector process converts known missing updates into locally downloaded files or folders, without naively querying every device for the update until one succeeds. Advantageously, missing updates can be learned without wasted bandwidth and computation by potentially querying devices that do not have the update. As an example, suppose the network 202 has three devices, d₁, d₂, d₃ (e.g., analogous to user devices 203, 205, and 206 in FIG. 2), sharing files. Device d₃ modifies object o, which propagates updates to d₁ and d₂. Upon receipt of that update for o, d₁ should only request to download the change from d₃, not wasting bandwidth and CPU resources by requesting from d₂.

The collector process records and shares, among peers, which updates each device has observed in the distributed system. The collector process will determine, and query from, the set of devices that are known to have the update. Given the set of devices known to have the update, the collector process selects devices to query in order of preference based on a device's network bandwidth, workload, etc.

Collector Data Structures: Sharing Existence of Local Updates

There exists locally, for every device d known to a local device, two sets of object ids: S_{xd} is the set of objects updated since the last version exchange between the local device and the known device d; and S_{hd} is the set of all other objects updated on the local device. The two sets are disjointed and their union represents all objects with updates downloaded on the local device. After performing an update locally on an object, the local device adds the object to the S_{xd} set, for every known remote device.

When responding to a pull version request from a remote device d, the local device additionally sends the set above, S_{xd}, of locally recorded updates. The remote device d will respond with success or failure. On receipt of a success message, the local device unions S_{xd} with S_{hd}, which records all objects ever updated at the local device, then empties the S_{xd} set. Thus, S_{xd} acts as a “diff” of objects updated between version exchanges of the local device and known remote device d.

Collector Data Structures: Collector Sets

Turning to FIG. 5, a set of objects, O={oₘ, . . . , oₙ}, is illustrated as a vertical queue with oᵢ currently at the head, and o₍ᵢ₋₁₎ at the tail, where 1≦m≦i≦n. These objects are known to have updates on remote devices, and are collected by cycling through the queue. Collecting an object involves requesting and downloading the update from a remote device. As discussed above, the collector process collect updates for all objects in the set O by contacting only those devices which actually have any given update available. The queue wraps the set O, giving the objects a particular order, where their sequence numbers are monotonically increasing—object oᵢ has sequence number i and therefore precedes o₍ᵢ₊₁₎. Object oₙ is adjacent to oₘ, where m is the minimum sequence number among the objects in O; m could take value 1, but objects are also removed from this queue. The current object to be collected is oᵢ at the head of the queue.

Also shown in FIG. 5 are sets C_{(di.t)}, illustrated as long rectangles. Whereas sets S_{xd} and S_{hd} (described above) record updates the local device has observed, the collector process relies upon the set C_{d}, which represents the objects for which device d has updates (i.e., the S_{xd} from d). Generally, there exists locally, for every device d known to the local device, one or more sets C_{(d.t)}, which were recorded locally as a result of exchanging versions for updates with device d. Because multiple version exchanges can occur with the local device and d, more than one of these sets may have been sent to the device d.

The set of sets C_{(d.t)} is hereafter called Collector Sets, or CS={C_{d1.0}, C_{d1.1}, . . . , C_{(dp.0)}, C_{(dp.1)}, . . . C_{(dp.tp)}}. As seen in FIG. 5, each set C_{(d.t)} is assigned to some index in the object queue O. A newly-received C_{(d.t)} is assigned to the tail at the bottom of the queue (e.g., C_{d2.1} in FIG. 5). There is no relation between C_{(d.t)} and the object which shares the same index; instead, this association is intended to safely discard the sets C_{(d.t)} when their use is expired. It is possible that more than one C_{(d.t)} set could be assigned to the same index, representing sets of objects from distinct devices. In another embodiment, when a local device receives several sets from device d, the incoming set can be unioned with the locally-present C_{d}. This approach is not taken so that Collector Set can be more easily pruned: if C_{(d.t)} sets remain separated, then an older set could be discarded while keeping the recently-received collector sets. The details of receiving a set C_{d} from remote device d is discussed below.

Collector Process: Method to Collect Updates Efficiently

Given the aforementioned data structures, the Collector process is described to collect the updates for each object in O, by contacting only those devices known to have a given update. Therefore, the set of devices to contact for object o that is a member of O is determined by querying for the existence of o in each C set.

To efficiently collect all objects in O, the local device “rotates” through the objects of the queue and downloads updates from the set of devices D, returned by the process above for each object. The local device discards the object sets {C} that are linked to the object popped from the head of O, as all elements in O that could appear in C have already been queried. If collection of some object o succeeds, the object o is removed from the queue.

On failure of downloading all updates for o from all devices in D, the sets received from devices in D are restored from a backup Collector Set CS_{bkup}. Details on how a set is inserted into the Collector Sets are discussed below.

Populating the Object Set and Collector Sets

Insertion to the Object Queue

Concurrent with the collection loop discussed above, the consistency process could receive knowledge of new updates for some object o. If the object is not already in O, it must be inserted, but not at the tail as in a conventional queue. To maintain the monotonic property of sequence numbers in O, the new object o is assigned a sequence number of n+1, and is consequently inserted into the queue following oₙ (as illustrated in FIG. 5).

Insertion to the Collector Sets

Following a push or pull version exchange from device d, a Collector Set C_{d} is additionally received or created on the local device. The non-empty C_{d} set can be added to the CS set while an empty C_{d} set can be ignored. In one embodiment, multiple C_{d} sets can be linked to the same object in the 0 queue, if the queue did not rotate between insertions to the Collector Set.

Upon receipt of a push version update from device d, after recording versions locally, the local device creates an object set C_{d} of all objects with new updates in the given versions. If all updates for some object o were already known locally, object o is not added to C_{d}. If C_{d} is non-empty, C_{d} is added to the Collector Set.

Upon receipt of a pull version response from device d, the local device first records the versions locally, including stable and unstable versions, as discussed above. As indicated earlier, device d sent its set S_{xd} of updated objects. These objects have updates on d that are new since the last pull version exchange made with d from the local device. If the received S_{xd} is non-empty, the local device records it as C_{d}, and adds it to the Collector Set. The local device subsequently responds to device d, indicating successful receipt of the set C_{d}.

Implementation Details

Bloom Filter Optimization

In one embodiment, the sets Sₕ and Sₓ (and consequently the C sets of CS) are implemented as Bloom filters of length 1024 bits and four hash functions. Bloom filters are space-efficient probabilistic data structures used to test whether an element (e.g., object o) is a member of a set (e.g., Collector Set), and are further described in Bloom, B. H. (1970), Space/Time Trade-offs in Hash Coding With Allowable Errors, Commun. ACM, 13 (7), which is fully incorporated herein by reference. The hash functions are disjoint bit selections from the 128-bit UUID object id. The CS Collector Sets is thus a set of Bloom filters. This implementation of the object id sets advantageously permits both constant-space transmission of object id sets and constant-time membership query of the collecting object in O, in each Bloom filter of CS.

Conflict Handling

A conflict occurs if two or more devices update the replicas of the same component at the same time. The system detects conflicts by comparing the version vector of a component received from another device with the local version vector. A syntactic conflict is detected if neither vector dominates the other. The present device adopts different methods to solve conflicts for metadata and content components. To solve conflicts for user-defined component types, an application developer writes conflict resolvers and registers them with a component plug-in framework.

Conflict Handling: Metadata Conflicts

When a metadata conflict is detected between two versions, the present device solves the conflict automatically by discarding an arbitrary version of the two. Because more than one device may independently detect and solve the conflict at the same time, it is important that the resolution process outputs the same result, regardless of when and at which device the process is executed, and from where the conflicting versions are received. To achieve this, the present system selects one of the two versions using the following method.

First, as part of metadata, a timestamp is associated with each object and is replicated with the object. When a device updates any part of metadata, it also updates the timestamp with local wall clock time. Second, the conflict resolution process compares the timestamps from the two conflicting versions, and selects the one with a smaller timestamp. Ties are broken by comparing the largest device ids from the two version vectors. A device id is said to be larger than the other if the former's lexical value is larger than the latter's.

Conflict Handling: Content Conflicts

According to one embodiment, when a content conflict is detected, both conflicting versions are kept as branches. The local version is kept as the master branch and the remote version is kept as a conflict branch. When a new update is received on a file that already has branches, the update's version vector is compared against the vectors of all the branches. If the update's vector dominates any branch, the update is then applied to that branch. Otherwise, a new conflict branch is generated.

File access made through the local file system is by default directed to the master branch. Therefore, users can continue working on their own branches if conflicts occur. Meanwhile, the present device exposes APIs that allow users to read-only access the content of conflict branches.

Users may examine conflict branches and then either merge the content into the master branch or simply discard the branch. In either case, they may issue an API call to delete a specified conflict branch. Upon receiving the call, the present device deletes the content of the branch, and “merges” the version vector of the conflict branch into the master branch, so that the new vector are the pair-wise maximum between the two vectors across all vector entries. The present device also increments the version number corresponding to the device in the new version vector.

Conflict Handling: Content Merger Plug-Ins

When merging the content of a conflict branch into the master branch, the user may choose to manually do so, or let the present device automate the process. Because how the content may be merged depends on the structure and semantics of the content which is application-specific, the present device relies on content merger plug-ins to merge files in application-specific ways. Applications register with content merger plug-ins. The plug-in may choose to automatically merge conflicting contents, or prompt and wait for user interactions.

Each plug-in is associated with a file path pattern specifying the set of files the plug-in is able to handle. For example, Microsoft Word may register a plug-in with file path pattern “*.doc” to handle all files ended with “.doc”. A calendar program may register a plug-in with pattern “*/calendar/*.dat” so it only handles files satisfying this pattern but not all files ending with “.dat”.

Content Handling: Content Conflict Presentation and Resolution in the UI

As discussed above, when a file is updated concurrently on two separate devices, a file conflict results. The updates made locally to this file o on a given device are present on the local file system, and any downloaded conflicting versions of the file are logically recorded as branches of o. In an alternative embodiment, a graphical user interface (GUI) is used to present the conflicting branches to the user. The GUI visualizes these conflict files branching from a common ancestor, including the device and user who contributed to creating each branch. Users are provided a button to open any files in a conflict branch to view its contents; these files are stored in a hidden directory. To resolve a file conflict, users can open all conflict branches, and their main local copy, and manually correct the conflict. Users are presented a button to choose branches to discard. Discarding a branch of object o creates a deletion update (see the Expulsion process discussed above) for that branch, and this update will be propagated to all other devices sharing that file.

Conflict Handling: Conflicting Name Updates

When two or more devices update different objects at the same time, no version conflicts would occur. However, these updates may cause name conflicts. For example, a name conflict occurs if one device creates a folder and in the meantime another device renames an existing file to the same name. The present device handles name conflicts as follows.

The present device arbitrarily discards one of the two conflicting updates. Two or more devices may attempt to solve the conflict independently at the same time. Therefore, a similar method is used. The present system compares the timestamps of the conflicting metadata and discards the one with a smaller timestamp. Ties are broken by comparing the object ids of the two objects.

Aliasing: Name-Conflict Resolution of Object IDs

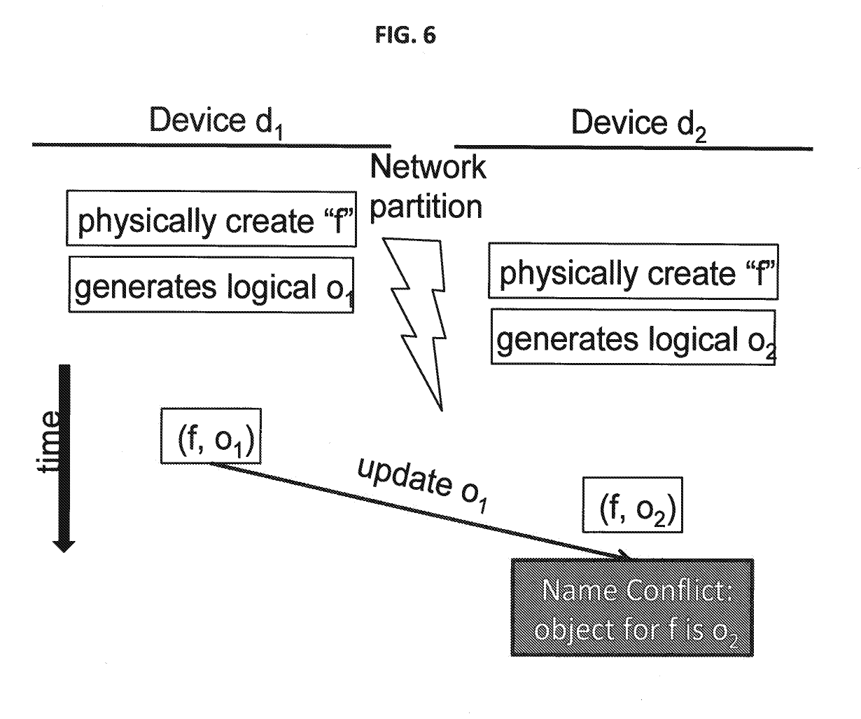

As discussed above, the core 307 generates an object identifier for every file and folder created on a device. The present system thus maintains logical objects that internally represent the physical objects on the local file system. At a local device, there must be a one-to-one mapping between the logical and physical objects, however remotely received updates can point two logical objects to the same physical path; these name conflicts result in two specific ways:
concurrent creation of a physical object (same pathname) on at least two peers, resulting in more than one distinct logical object (as shown in FIG. 6); and
when one peer locally renames an existing physical object to the same path as a physical object created on another peer.

Henceforth in this section, the term object will refer to logical object for brevity, and physical object will be stated outright.

When peers exchange information about distinct logical objects that represent the same-named physical object, as in FIG. 6, this name conflict must be resolved. Turing to FIG. 6, devices d₁ and d₂ are initially separated by a network partition. In that partition, they both create a physical file (or directory) with equivalent path “f,” which yields two distinct object ids, o₁ and o₂. Subsequently, the network partition is removed, and device d₁ sends its update that object o₁ has been created with path “f.” Device d₂ discovers that it already has a logical object o₂ for path “f,” violating the invariant that logical and physical objects must have a one-to-one mapping.

In one embodiment, resolving a name conflict includes deterministically renaming one of the two objects involved in the name conflict. However, it is conceivable that some users of the system could already have files replicated on multiple devices, leading to name conflicts on several files, and this renaming approach will then create n copies of the same file, where n is number of peers with the replicated file.

In another embodiment, an aliasing process will be discussed to avoid renaming and duplicating files/directories, and, instead, opting to alias one of the name-conflicting objects as the other.

Merging Alias and Target Objects

During a name conflict, specifically it is the differing object ids for the same physical object that conflict. The aliasing process labels one of the object ids as the target, and the other as the alias. The device observing the name conflict merges all meta-data describing the alias object into the target, (i.e., consistency process versions discussed above), then subsequently replaces all meta-data about the alias object with a pointer relationship, and shares that pointer relationship with other devices. The assignment of alias and target objects must be deterministic, so that all devices which encounter the same name conflict will label the same object as the target, and other objects as aliased. To this end, since object ids can form a total order by value, the value of object ids is used to determine the target and alias assignment. Specifically, given a set of n object ids involved in a name conflict, in one embodiment of resolving the name conflict, the object id which will become the target, oₜ, has the maximum value in the set: oₜ=max({o₁, . . . , oₙ}).

Alias Version Updates

Nearly all meta-data for the aliased object is merged into the target, including version vectors, except for the versions associated with the aliasing operation itself. When oₐ is aliased to oₜ at the local device, the change in state must be propagated to all other devices to achieve a consistent global state. Therefore, a new version must be created for oₐ, but all other versions describing the previous file updates on oₐ must be merged into oₜ, so that oₜ covers the version history of its alias objects. In this patent, the system updates version vectors by drawing from two spaces, one for alias updates, and the other for all other object updates. When merging versions from the alias object into the target, only versions from the non-alias space are merged; the alias object keeps its alias version history.

In one embodiment, version vectors for the alias update space have odd-valued integer counts, whereas version vectors for the non-alias update space have even-valued integer counts. As with classic version vectors, the integer counts must be monotonically increasing for events with a happens-before relationship.

Object State Model

A state transition model summarizes the initial state and expected result of the aliasing process. Defined first is a simplified model of the logical states which can represent a physical object at a single device. The simplified model considers only the metadata of a physical object, not content.

Let (n, o) represent a physical object with a path n, and logical object id o; the object o is called a non-aliased object. If logical object oₐ is known to alias to o, then we write oₐ→o, knowing that oₐ is an alias object for target o. The alias relationship (i.e., the pointer) is stored for an aliased object.

State

In the case above, where object oₐ aliases to (n,o), the state of the physical object n is {(n,o), oₐ→o}, which means that file/directory n is logically represented by object o, and any system references to oₐ will alias (or are derefenced) to object o. Resulting from transitions, the name-conflict resolution strategy permits only “acceptable” states, which abide by the following two invariants:
all states must include one and only one non-aliased object; and
the target of all aliases must be the non-aliased object—alias “chains” are not permitted.

These invariants simplify the verification of correctness. The first invariant means that a device cannot download information about an aliased object oₐ if its target o_{f} does not exist locally. This is somewhat analogous to avoiding dangling pointers in the C programming language. The second invariant avoids creating chains of aliases, e.g., {o₁→o₂, o₂→o₃}. Since o₂ is not a non-aliased or target object locally, o₁ should not refer to it. As will be discussed below, when referring to a target object, it can be certain to exist locally as a non-aliased object.

Transitions and Messages

Since name conflicts are discovered when receiving an update about an object, transitions among states are spurred by messages between devices. In a name-conflict resolution method, the local device can receive two types of messages about any object in the system from any other device: (i) a non-alias message; or (ii) an alias message. A non-alias message is labeled and contains meta-data of the form (n, o), implying that the sender device has provided the local device with an update about file/directory n with logical object o that is not aliased on the sender. An alias message is of the form oₐ→oₜ, implying that there is an update about oₐ, and the remote device thinks its target is oₜ.

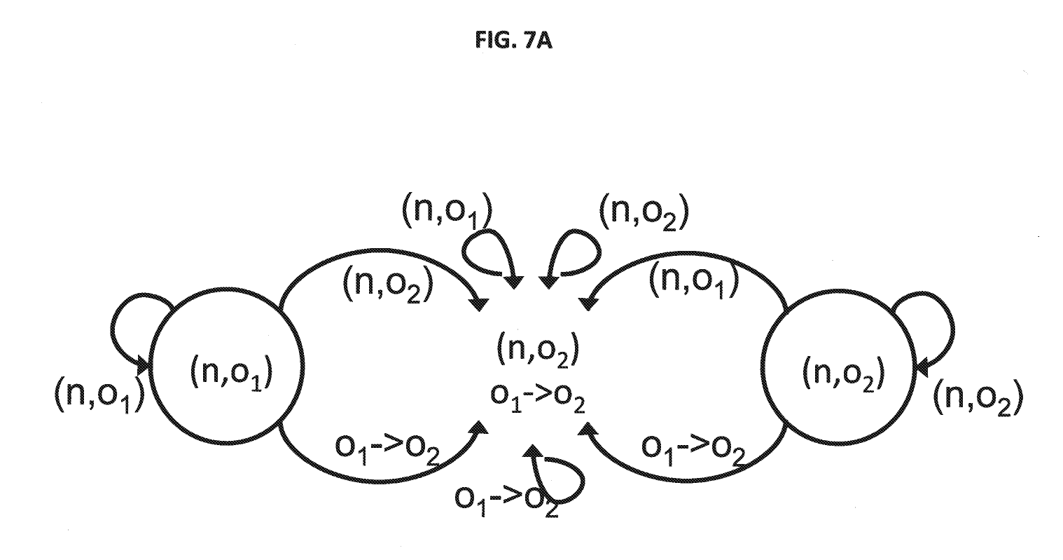

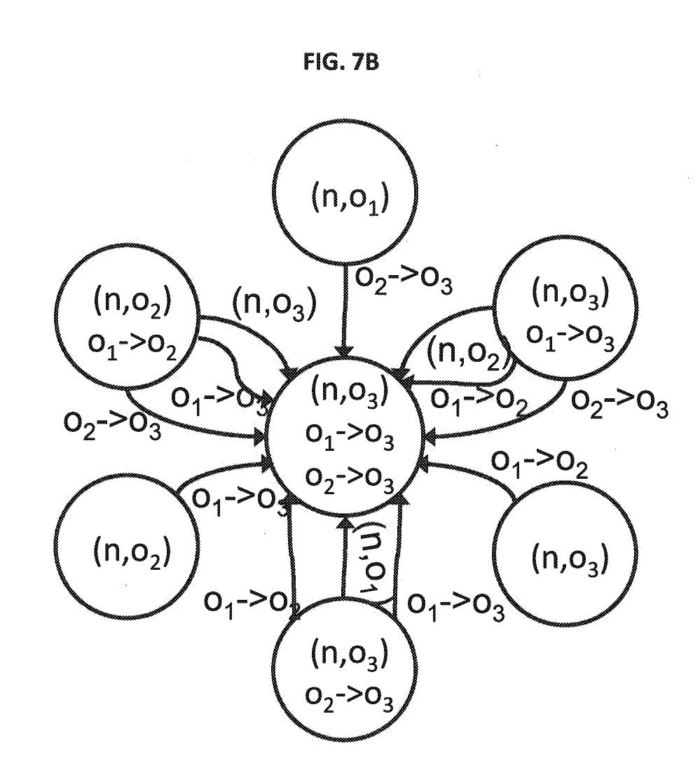

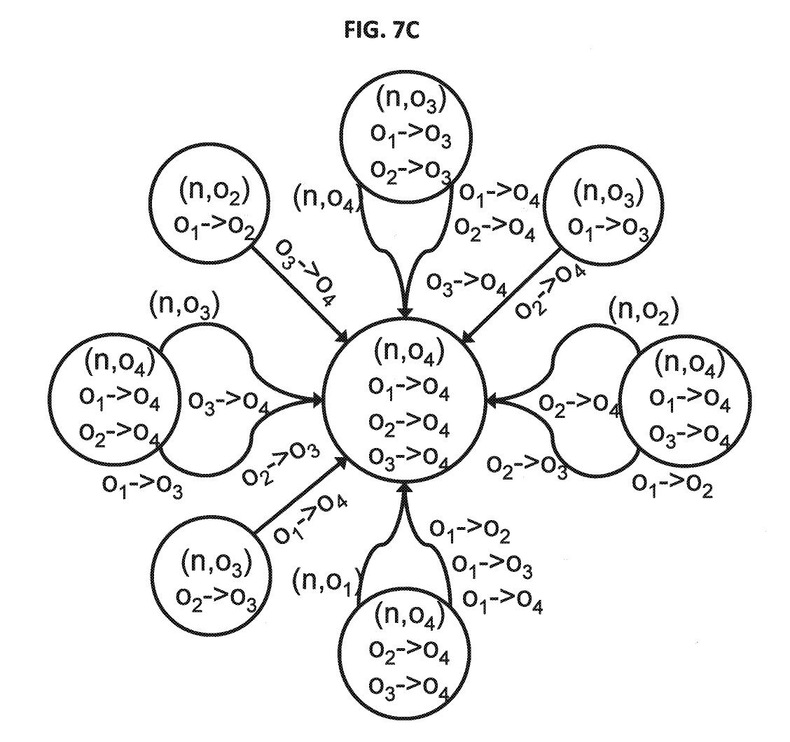

In FIGS. 7A-C, acceptable states are represented as large circles or nodes, including the non-aliased object, (n, o), and any objects aliased to o. For example, at the center of FIG. 7A is a node representing the state {(n, o₂), o₁→o₂}. The other nodes in FIG. 7A represent states {(n, o₁)} and {(n, o₂)}. In FIGS. 7A-C, an arrow (directed edge) shows the expected transition from a state when a particular message about an object has been received. The state transitions are agnostic about the source device. As previously discussed, arrows represent transitions, not messages, but are labeled by the message that induces the transition. Sample transitions can be seen in FIG. 7A, such as when a device in state {(n, 00} receives an alias message o₁→o₂, then subsequently transitions to state {(n, o₂), o₁→o₂}.

Object State Transition Diagrams

FIGS. 7A-C show all possible states that a physical object n can occupy given a replication factor, and all expected transitions across those states, according to one embodiment.

Turning to FIG. 7A, a state diagram is shown where physical object n has two replicated logical objects o₁ and o₁, which are ordered such that o₁<o₂. Thus o₂ is the eventual target, and o₁ should become the alias. The center node represents state {(n, o₂), o₁→o₂}, which implies that the name conflict on (n, o₁) and (n, o₂) has been fully resolved. The resulting transition is shown for all three possible types of messages ((n, o₁), (n, o₂), o₁→o₂) from each state. Notice that if all three messages are eventually received, the final resulting state is the fully-resolved state.

FIG. 7B considers a scenario where physical object n has three replicated logical objects, which are ordered such that o₁<o₂<o₃. In this scenario, o₃ is the eventual target, with o₁ and o₂ becoming the aliases. The center node represents fully-resolved state {(n, o₃), o₁→o₃, o₂→o₃}. From this center state, receipt of messages (n, o₃), o₁→o₃, o₁→o₂, or o₂→o₃ will transition back to the same state (omitted from FIG. 7B for brevity). The three states from FIG. 7A can be seen in the left portion of FIG. 7B. The state transitions among them that were previously shown are hidden for brevity, but would otherwise exist in FIG. 7B for completeness. The bottom three states, {(n, o₂)}, {(n, o₃)}, and {(n, o₃), o₂→o₃}, model another 2-object conflict resolution, and thus share identical transitions to those in FIG. 7A, by simply replacing references to o₂ with o₃, and o₁ with o₂. Likewise with the three states, {(n, o₁)}, {(n, o₃)}, and {(n, o₃), o₁→o₃}, in the right side of FIG. 7B. Thus, in FIG. 7B, all transitions that are described in a 2-object conflict scenario are omitted to avoid redundancy, but remain intrinsic to the state model.

FIG. 7C extends the latter two scenarios to four replicated objects with ordering o₁<o₂<o₃<o₄. Turning to FIG. 7C, there are four outer states with one non-alias object and two aliases, three outer states with one non-alias and one alias, and at the center is the fully-resolved state with one non-alias (n, o₄) and three aliases to o₄. As seen in FIGS. 7A-B, some redundant transitions and states are omitted in FIG. 7C for clarity. The top state {(n, o₃), o₁→o₃, o₂→o₃} is equivalent to that in FIG. 7B. All states and transitions that describe a 2- or 3-object resolution should additionally appear in FIG. 7C, but are omitted as they are redundant when considering FIGS. 7A-B. The three other 2-alias states of FIG. 7C can be surrounded with identical state hexagons with one of the objects replaced. FIG. 7C shows states with one alias object (e.g., {(n, o₂), o₁→o₂}) because after receipt of a particular alias message (o₃→o₄), the local device should transition to the center, fully-resolved state. In contrast, from a state with no alias objects (e.g., {(n, o₂)} not shown), there is no single alias nor non-alias message that will transition to the fully-resolved 4-object state. From the center state, receipt of the following messages will restore to the same state: (n, o₄), o₁→o₂, o₁→o₃, o₁→o₄, o₂→o₃, o₂→o₄, o₃→o₄.

Although not illustrated, it should be understood that the teachings of FIGS. 7A-B can be further extrapolated for five, six, or more replicated objects. For example, a scenario with five replicated objects would have a center state with four aliases and one non-alias. The center of FIG. 7C would be among the five surrounding states with three alias objects. One must also consider the states which can transition to the fully-resolved state through one alias message.

In one embodiment, logical objects must represent the same type of physical object in order to be aliased (i.e., both the remote and local objects must be a file, or both must be a directory).

Pins

According to one embodiment, users assign user pins to arbitrary files and folders. As previously described above, subsets of the data to be kept in a device are determined based on object usage pattern. A device may not have the entire dataset of a library if its space is constrained. When a user accesses objects that are not stored locally, object data is streamed from other devices. However, in some circumstances, the user may want some objects always accessible locally. Pinned files and all the files under pinned folders are never removed from the device, unless the amount of pinned files exceeds the capacity of the device. In this case, the user pin flags are disregarded and pinned files get evicted. The user is notified of the capacity issue.

Pins: Auto Pins

According to one embodiment, a user can specify the least number of copies of a file which should be available globally, for availability or other purposes. Because files may be evicted from any device, at least one copy of any given file must be guaranteed to exist at any time. This per-file number is a replication factor, “r”. It is one by default.

According to one embodiment, when a file is created, the file is replicated to r devices, including the local device, and an auto pin is assigned to the file on each of the r devices. The file creation procedure blocks until all these operations complete. Files that are auto pinned are not allowed to be evicted under any circumstances, whether the files are user pinned or not. Thus, the system guarantees that there are at least r replicas.

Pins: Auto Pin Handoff

If the amount of auto pinned files is about to reach the capacity of the device, the device may hand off auto pinned files to other devices. To hand off a file, the initiating device replicates the file to the receiving device, sets the auto pin flag on the receiving device, and then removes the auto pin from the initiating device. Once the auto pin is removed, the initiating device is free to evict the file. Handoff needs to be negotiated, because the receiving device may not have enough space, either. When a handoff request is rejected, the initiating device needs to search for other devices willing to accept the request. Otherwise, it will not be able to reclaim space.

Pins: Auto Pin Rebalancing

According to one embodiment, handoff happens not only when a device's storage is full. Each device continuously hands off auto pins to other devices to keep the amount of auto pinned files under a certain threshold t1 relative to the capacity of the device, so that the entire system can be balanced in terms of replica distribution, data availability, and device load. In order to avoid thrashing, a device may refuse to accept handoff requests for the purpose of auto pin rebalancing, if the amount of auto pinned files on that device has exceeded a threshold t2 relative to device capacity. Threshold t2 is always greater than t1.

Installation

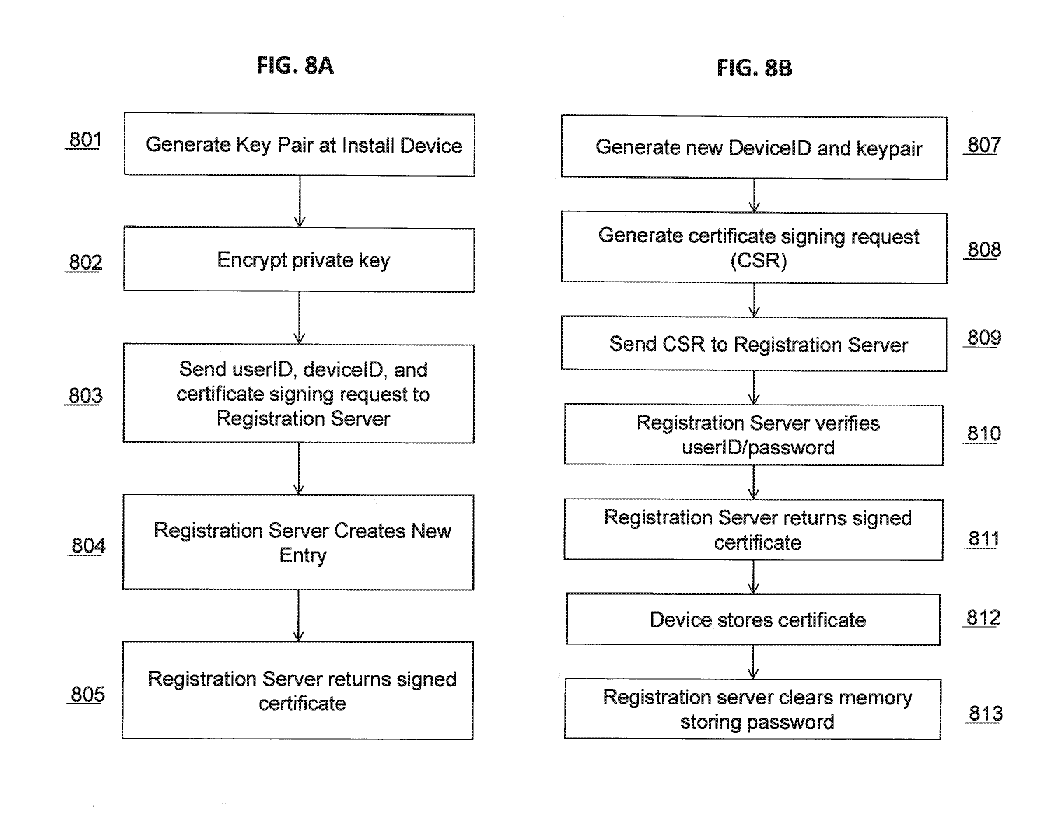

FIG. 8A illustrates an exemplary initial installation process for use with the present system, according to one embodiment. During initial installation, a new user public/private key pair is generated by the install target (i.e., computer, device) 801. The private key is encrypted using the user's provided password (examples of encryption algorithms include PBKDF2 and AES) 802. The user ID, as well as a device ID (generated by the device) and a Certificate Signing Request (CSR) (derived from the user's public key and device id, discussed above) are sent to the registration server 803. The registration server in turn creates a new entry for the user 804. The server also returns a certificate signed by the CA to the user device 805. The server returns an error ode if either user or device id is already registered.

According to one embodiment, the above information is also permanently stored on the install target. The user and device id is saved in an ASCII configuration file; the certificate and the encrypted private key are saved in separate, BASE64 encoded files. The password is saved in the configuration file, encrypted with a symmetric key. The user may delete the password from the configuration file, which forces the system to prompt for a password upon every launch.

FIG. 8B illustrates an exemplary subsequent installation process for use with the present system, according to one embodiment. On subsequent installations, a new device id and public/private key pair is generated 807. A new certificate signing request (CSR) is generated derived from the user's new public key and device id 808. The certificate signing request is sent to the server 809. The server verifies the user id and password 810, and upon successful verification, the server will return a certificate signed by the CA to the user device 811, which in turn writes them to local memory 812. Upon verification, the registration server clears the memory region holding the password 813.

User Login

According to one embodiment, users are prompted for a password upon login. The password is used to decrypt the private key stored on the local drive, and then the key is tested against the locally stored public key using the challenge-based method.

According to one embodiment, the challenge-based method takes a public key and a private key as the input and outputs a Boolean value indicating whether the private key matches the public key. The method generates a randomly generated payload using a secure random number generator and encrypts the bytes with the public key (one possible encryption algorithm is RSA/ECB/PKCS1 Padding). The encrypted data is decrypted with the private key and is then compared against the original payload for equality. The overall method returns true if all the steps succeed and returns false otherwise.

According to one embodiment, no communication is required between the client device and the registration server for user login. This is to facilitate offline operations.

Remote User Authentication

A user is authenticated to the local system upon login. However, in order to interact with remote devices, distributed authentication is required. Unlike server-based solutions such as Kerberos, the present system performs peer-to-peer authentication for maximum availability. To automate the authentication process, the user's decrypted private key and public Certificate is stored in memory after the user logs in, and this key and Certificate pair is used whenever a peer authentication is requested using standard PKI DTLS/TLS procedures involving certificate exchange.

If a user failed to authenticate to a library, because the certificate is invalid, she is automatically treated as an anonymous user, and granted access to the operations available to anonymous users.

Library Authentication

While users must be authenticated for library access, devices also need to prove to the user the authenticity of the libraries they are serving. Therefore, a certificate is associated with each library.

The user may create a new library on any device she owns. The device is in fact the first contributing device of the new library. During library creation, the device generates a public/private key pair for the library, and sends a Certificate Signing Request to the Certificate Authority. Upon receiving the certificate from the CA, the creating device saves both the certificate and the private key in plaintext into the administrative directory of the library, protected with proper access permissions, so that devices that contribute to the library can use these materials to proof the library's authenticity to remote devices.

When a user accesses the library from a remote device, a standard bi-directional certificate exchange authentication scheme is used to authenticate both the user and the library at the same time, as well as to establish a secure channel between the two parties. The handshake terminates immediately if the library cannot be authenticated. Because libraries are operated independently, there might be multiple secure channels between two devices at the same time, one for each library.

Distributed Access Control List (ACL)

According to one embodiment, the present system imposes discretionary access control (DAC). Each object (or file) is assigned an access control list (ACL) specifying which users may perform what operations on the object. ACLs are part of object metadata, synchronized across devices the same way as other object metadata does. ACL follows DAC semantics found in Microsoft Windows®. ACLs are the building block for higher-level security services like membership management. In another embodiment, the ACL specifies access permissions for an entire library (also known as a store), as discussed above. In this embodiment, the ACL is a mapping from user IDs to permission on the contents of the store. A device is permitted to sync the objects of a store if its owning user ID in the Access Control List (ACL) of the store. Each device has a root store with only the owning user in the ACL; this root store thus syncs only with devices owned by the user.

An object o may be moved between stores, say S₁, and S₂. In some algorithms, it is important to distinguish o under S₁ vs S₂, and thus, as used in this disclosure, will be annotated as (S₁, o) to reference object o under store S₁.

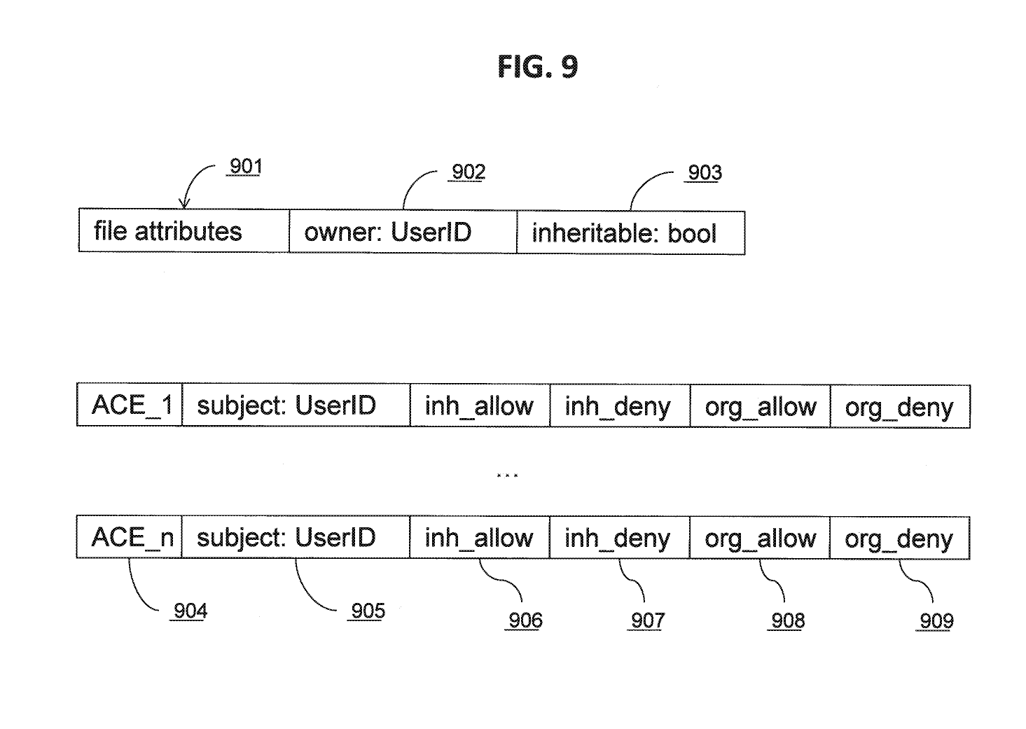

FIG. 9 illustrates an exemplary access control list for user with the present system, according to one embodiment. Attributes 901 specifies the owner 902 of the object, with initial value being the user id of the device where the object is created. The attributes 901 also includes an inheritable field 903 that specifies whether to inherit Access Control Entries (ACEs) from the object's parent object with initial value true. An ACL may also contain zero or more ACEs, each specifying access rights for a particular subject. The initial ACL is empty.

An ACE 904 has several fields. An org_allow field 908 specifies the rights allowed to the subject and field org_deny 909 specifies the rights denied to the subject. Fields inh_allow 906 and inh_deny 907 define allowed and denied rights that are inherited from the parent, respectively. The value of these fields is a combination of zero or more rights. A right is a set of operations. Supported rights and their corresponding operations are listed in Table 1 below. A subject field 905 specifies the user(s) of whom the ACE controls access.

Permission checking is enforced for both local and remote operations. The login user is regarded as the subject for local operations. When a remote operation is attempted, the remote device's owner is the subject. For example, when user A's device D sends an object O to user B's device E, D checks if B can READ O, and E checks if A can WRITE O. The transaction proceeds only if both conditions are satisfied.

TABLE 1
Rights and Operations

| Rights | Operations |
|---|---|
| READ | Read metadata including ACL |
| | For files: read content |
| | For dirs: list the children that |
| | the subject may READ |
| WRITE | Write metadata excluding ACL |
| | Rename the object (name and parents |
| | are part of metadata) |
| | Move the object if the subject may |
| | WRITE both source and |
| | destination directories |
| | Delete the object if the subject |
| | may WRITE the parent |
| | For files: write content |
| | For dirs: remove or add children |
| WRITE_ACL | Update any field in ACL |

Solving ACL Update Conflicts

When two devices update an ACL concurrently (i.e., the two updates have no causal relationship), a metadata conflict occurs. When a device detects a metadata conflict, the present system solves it automatically by selecting an arbitrary version from the two and discarding the other one. Because more than one device may detect and solve the conflict independently at the same time, it is important that the resolution process outputs the same result, regardless of when and at which device the process is executed, and from where the conflicting versions are received. To achieve this, the present system selects one of the two versions using a deterministic method as described herein.

Administrative Directory

Similar to /etc on UNIX systems, there is a special directory in each library. All administrative tasks for the library such as user and device management are done by manipulating objects and their ACLs within the directory. Although users may do so manually, the present user interface helps accomplish common tasks with a few mouse clicks. For example, the interface provides three user types. When a user is given a certain type, the interface applies predefined permissions to various objects, so that the user is able to perform tasks that are privileged to that type. Example user types and their privileges are:
Managers. Add and remove Managers and Contributors, plus Contributor's privileges.
Contributors. Contribute owned devices to the library.
Others. No privileges except to access objects the user is permitted to.

According to one embodiment, users with appropriate permissions may override user types and privileges by manually changing ACLs. Table 2 lists objects as well as their predefined permissions for Managers and Contributors (Others have no permissions at all).

TABLE 2
Objects & Permissions

| | | | |
|---|---|---|---|
| | | org_allow | |
| | | for | org_allow |
| Path | Inheritabl | Managers¹ | for Contributors¹ |

Comments

| | | | |
|---|---|---|---|
| / | T | RWA | RW |

The root directory

| | | | |
|---|---|---|---|
| /.aerofs | F | RWA | R |

The administrative root

| | | | |
|---|---|---|---|
| /.aerofs/users | T | Ø | Ø |

The directory for per-user data

| | | | |
|---|---|---|---|
| /.aerofs/users/u | T | Ø | Ø |

The directory for user data where u is a user id.

| | | | |
|---|---|---|---|
| /.aerofs/users/u/devices | T | Ø | W or Ø² |
| The directory for per-device data | | | |
| /.aerofs/users/u/devices/ d | T | Ø | Ø |

The directory containing information of a contributing device, where d is a device id.
From any device's point of view, a device contributes to the library if and only if
there is such a directory corresponding to this device.

| | | | |
|---|---|---|---|
| /.aerofs/users/u/devices/d/device.conf | T | Ø | Ø |

Device configuration file specifying device aliases etc.

| | | | |
|---|---|---|---|
| /.aerofs/users/u/devices/d/var | T | Ø | Ø |

The device writes files into this directory to notify its runtime statistics to other
devices.
¹R = READ, W = WRITE, A = WRITE_ACL. The org_deny field is Ø. Inh_allow and inh_deny fields are computed.
²W if the Contributor's user = <user> and Ø otherwise.

### Example

### Add a Contributing Device to a Library

A better understanding of how components work together is achieved through the following example. The example involves adding a Contributor C to an existing library L. C then contributes her device D to L.

An existing Manager M adds user C from M's own device E. Device E performs the following steps:
Create directories L/.aerofs/users, /.aerofs/users/uc, and /.aerofs/users/uc/devices, where uc is C's user id;
Add ACE: object=L/, subject=C, org_allow={WRITE, READ}, org_deny=ø;
Add ACE: object=L/.aerofs, subject=C, org_allow={READ}, org_deny=ø;
Add ACE: object=L/.aerofs/users/ucdevices, subject=C, org_allow={WRITE}, org_deny=ø.

The updates are then propagated to other devices. Because M as a Manager has full access to objects under /.aerofs, he is allowed to update them, and E is allowed to send these updates to other devices.

Subsequently, when user C instructs her device D to contribute to L, D first finds a device F that contributes to L. Assuming F has applied all the updates made by E, F is able to verify D's authenticity by using C's certificate and establish a security channel with D.

Device D then retrieves from F the directory L/.aerofs/users/uc/devices, and creates a new directory UD as well as a new file uD/device.conf under this directory, where uD is the device id of D (the parent directory is replicated locally before new objects can be created within it). The new directory is pushed to device F, so that F can recognize D as a contributor of library L and start synchronizing with it.

As directory L/.aerofs/users/uD/devices/uD gets propagated to other devices, they start recognizing D. Eventually, all contributing devices of L will recognize D, which concludes the entire joining process.

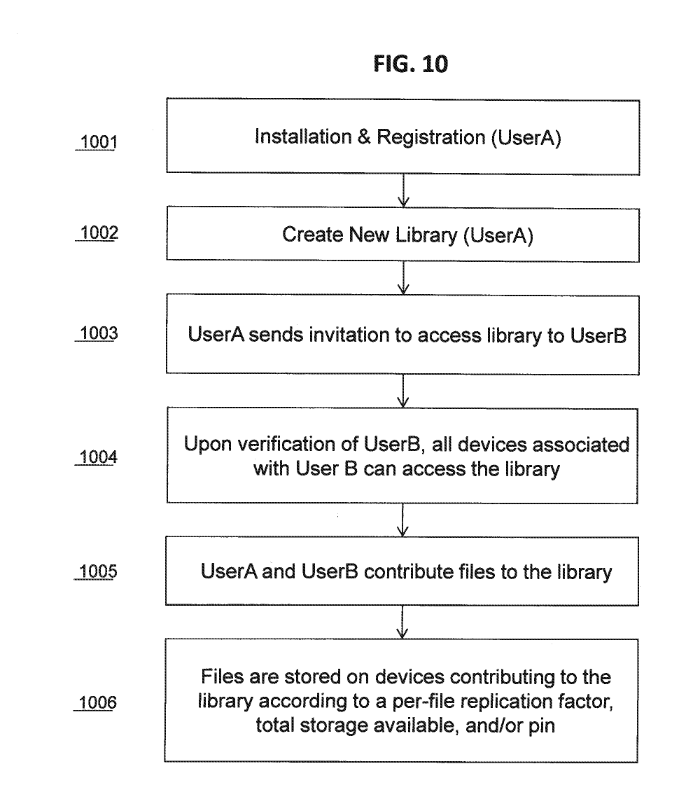

FIG. 10 illustrates an exemplary library management process for use with the present system, according to one embodiment. A user (UserA) installs library management software on a device and registers the device and the user with a registration server (action block 1001). UserA can then create a new library (action block 1002) and invite others to access the library. In this example, UserA invites UserB to access the library (action block 1003). UserA's device verifies UserB and grants access to the library (action block 1004). In this case, all devices associated with UserB are granted access to the library. As UserA and UserB contribute files to the library (action block 1005), they are able to assign a replication factor to each file and/or pin each file to a particular device, as discussed above. As such, files are stored on devices having access to the library according to a per-file replication factor, the total storage available, and any pinning that has been designated (action block 1006). Examples and detailed descriptions of replication factor, pinning, total storage, contributing to a library, creation of library, verification, devices, and registration server have been described in the foregoing sections of this document.

Expulsion: Propagation of Deletions and Selective Sync

The system propagates file and folder deletion updates among devices as one type of object update. Users are additionally permitted to specify those files and folders which they would not like to sync to a particular device (but which remain synchronized among all other devices). Common to both features is the method of labeling a file or folder as “expelled.” In one embodiment, among other data stored in the logical representation of the file system (e.g., name, object id), the system stores a boolean expelled flag for each object.

Expulsion: Selective Sync

Initially all new objects are flagged as false (admitted). To unsync a file at the local device, the expelled flag is set to true, and the file is consequently deleted from the physical file system, without incrementing versions in the consistency algorithm (i.e., do not create an update about this deletion). To unsync a directory, it is flagged as expelled, along with all descendent files and directories in the logical file system. The aforementioned physical files/directories are deleted. If the parent directory of an object is expelled, then that child object must necessarily be expelled as well. No versions are incremented in the consistency process, discussed above, when a folder and its children are expelled; this is a local operation, not to be shared with other devices.

Deletion Propagation Via a Logical Trash Folder

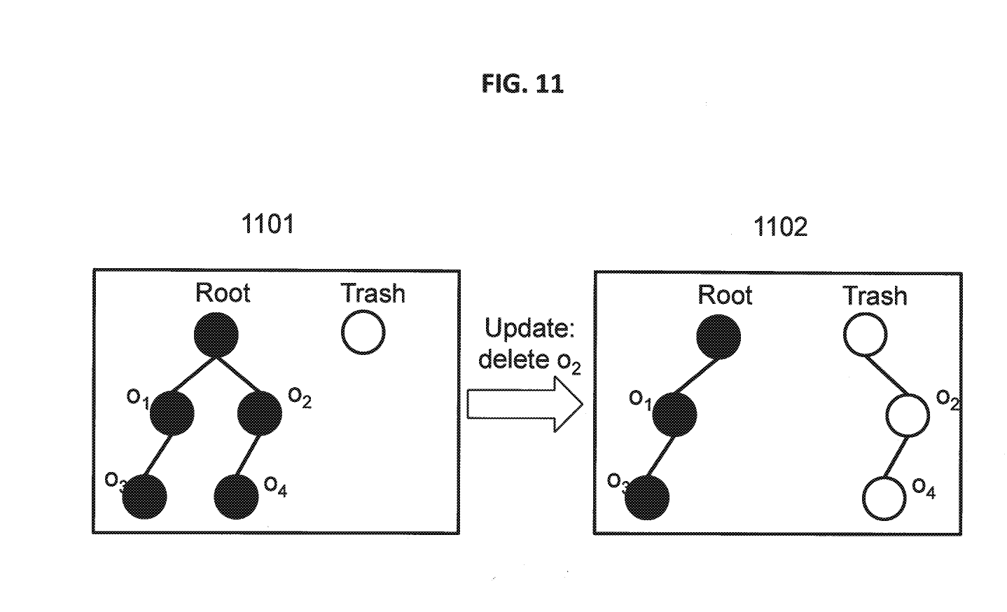

Unlike selective sync, where an object is physically deleted on only one device, but synced among all others, the system additionally supports the propagation of deletions. This feature relies on a special directory that is expelled in every store, known as the trash folder, shown in FIG. 11. Turning to FIG. 11, an initial tree representation 1101 of a logical directory tree having tree nodes o₁-o₄ is shown. Tree nodes o₁-o₄ are logical objects representing directories or files; nodes with children are necessarily directories on the physical file system. For example, the node labeled “Root” is the root directory of the store, with two children directories o₁ and o₂, which have one child object each, o₃ and o₄, respectively. Empty (or white) nodes represent expelled objects, and full nodes are not expelled. The trash folder is always marked expelled, thus it appears only in the logical file tree, not on the physical file system. In every store, on every device, the trash folder has the same object id.

To propagate a deletion update for an object, the object is moved to the trash folder, as demonstrated in FIG. 11. In the initial tree representation 1101, directory o₂ was under the root directory. The system is notified that, locally, o₂ has been deleted. Thus, o₂ is logically moved under the trash folder. Because children of an expelled folder are also expelled, o₂ and its children are expelled. As with all object moves, the logical movement of o₂ to the trash folder warrants a version increment for o₂ in the consistency process. Via the Collector Process, remote devices will collect the update that o₂ has been moved under the trash folder. Therefore, the remote devices will set the expelled flag on o₂ after moving it under the trash folder, and delete o₂ from the physical file system. Hence, object deletions are propagated by logically moving objects under the known, expelled trash folder.

Migration: Moving Files Across Store Boundaries

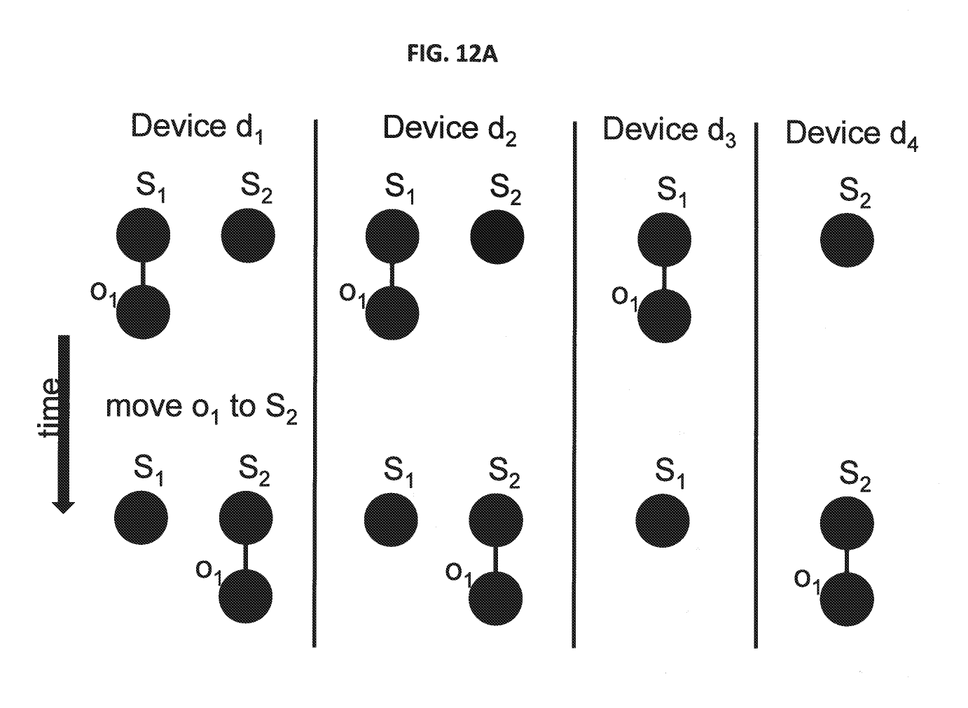

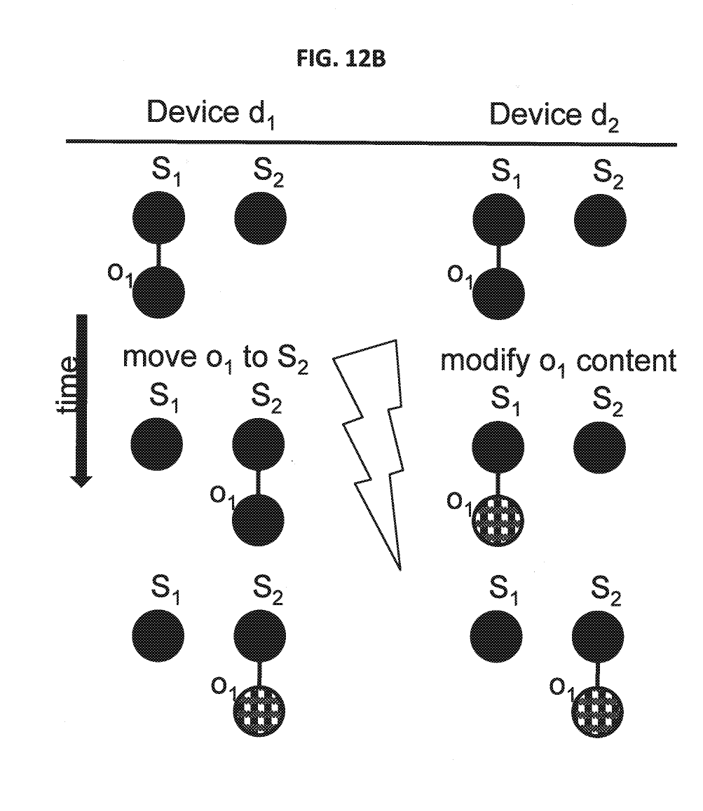

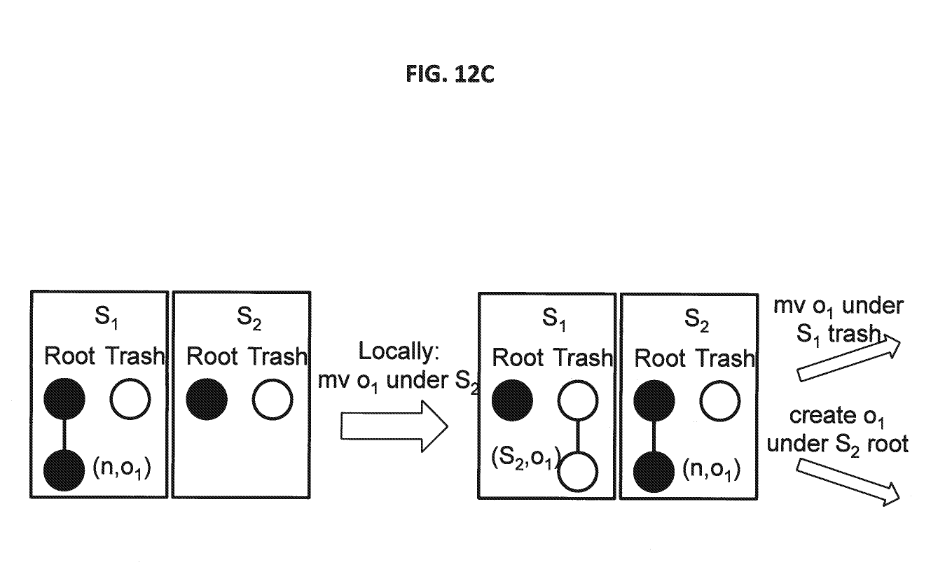

As previously discussed, a store defines a set of users who are sharing a directory and its contents. Moving an object between stores deserves special consideration. The system supports the ability to delete files when moved out of a store, or move files among stores, depending on the context. The problem is illustrated in FIG. 12A. Additionally, the system maintains cross-store version history, providing a causal history for an object that crosses store boundaries, as seen in FIG. 12B.

FIG. 12A shows the state of two stores, S₁ and S₂, on four devices, d₁, d₂, d₃, d₄, after moving an object between the two stores S₁ and S₂. Devices d₁ and d₂ are subscribed to both stores. Device d₃ is subscribed to S₁ only, and d₄ to S₂ only. Initially, object o₁ is under the root directory of store S₁, and all devices are consistent with this state. Device d₁ moves o₁ into store S₂. The system supports the following state transitions when each of devices d₂, d₃, and d₄ receives the update of the cross-store object movement.
on d₂, the object is physically moved, without deleting and re-downloading the content of o₁;
on d₃ the object is physically deleted; and
on d₄ the object is downloaded and physically created.

The Collector, Expulsion, and update propagation processes discussed above are store-centric—thus, what should be a simple move operation between stores on d₂ could be naively implemented atop these processes as separate deletion and creation operations. A device receiving the deletion and creation updates would, thus, naively re-download the file, even if the content had not changed. Through the method of migrating a logical object between stores, the system avoids naively deleting the object from S₁, then re-downloading the object into S₂.

FIG. 12B illustrates the goal for cross-store version history. Initially, object o₁ is consistent under store S₁, on both devices d₁ and d₂. During a network partition, device d₂ modifies the content of o₁ (indicated by the modified pattern of the node), but leaves the object in store S₁. Concurrently, device d₁ moves the object to store S₂ with the original content. The network partition then disappears and the two devices propagate their updates. By maintaining the identity of o₁ across stores, and maintaining the version history, a final state can be achieved where o₁ is under store S₂ with the new content applied while it was under S₁. Without tracking identity and the cross-store version history, there would be two files, one in each store, and only one would have the updated content.

The system observes the migration of the object id o₁ and maintains the consistency process version history of the file, through (i) respecting the invariant that a given object can be admitted in only one store at any time (as in the Expulsion process above), and (ii) an extension to the versioning system of the consistency process, called immigrant versions.

State Change when Instigating Migration

FIG. 12C shows the logical state change after an object o₁ is physically moved between stores S₁ and S₂ on the local device. Initially object o₁ with name n is under the root folder of S₁, and S₂ has no child object. Following the physical move, under store S₁, the object is effectively deleted as indicated in the Expulsion section discussed above, by logically being moved under the trash folder, and thus expelled. Notably, under the trash folder, the name of the object is the store id of S₂, the target store to which o₁ was moved. Under store S₂, object o₁ is created in the admitted state. As with the usual consistency process, these two logical state changes generate two updates which are propagated to other devices:
o₁ was moved under the S₁ trash folder with name S₂, and
o₁ was created under the S₂ root folder with name n.

The physical object maintains its logical object id across stores in an effort to easily identify migration, and maintain its version history despite store migrations.

On Deletion Update

Consider a device which subscribes to store S₁; it will receive the first update, that o₁ was moved to the trash folder. Because the new name of o₁ under store S₁ identifies the store to which o₁ emigrated, the device receiving this update can infer the new store of o₁. In one embodiment, a method to handle migration-induced deletions determines the target store of the object to be migrated, then defers to the handler of creation updates, which will be discussed below. Because migrated objects keep the same logical identifier, once the deletion handler has determined the target store, it can simply request the object under that store. A non migration-induced deletion will be handled by the Expulsion process, described above.

On Creation Update

Now consider a device which subscribes to store S₂; it receives the second update, that o₁ was created under S₂ with name n. In a typical work flow, the object is physically downloaded, but to avoid redundant transfers, the local device first determines whether o₁ is admitted in any other store. If o₁ is admitted in another store, the local device migrates o₁ under S₂ by physical file movement. The creation update concludes by deleting o from the source store, and recording its migrated target store. This action implicitly will create a new version update on the local device, which will be propagated to other devices. However, all devices that subscribe to the target store S will perform the same action, generating false version conflicts. Such version conflicts can be resolved as discussed above.

Immigrant Versions: Cross-Store Consistency

As previously discussed, update propogation is achieved through push and pull of version vectors. This section is mainly concerned with pull requests. Naively, a device could respond to a pull request by sending its entire local set of version vectors. However, the two devices may share many of those versions, resulting in much redundant bandwidth waste. As discussed above, in one embodiment, the stability of version vectors can be achieved by defining a knowledge version vector, present locally on a device, for every store. All integer counts below the knowledge vector of the local device are assumed to be stable—no new version needs to be requested whose integer count is below the knowledge vector. Because of this invariant, when issuing a pull request, a device X can send its knowledge vector to device Y, and device Y can respond with only those versions which are above the given knowledge vector. Additionally, device Y responds with its knowledge vector after the version exchange so that device X can increase its own vector accordingly.

The migration of an object across stores requires special consideration with regard to the knowledge vector. Accordingly, in another embodiment, to ensure that pull-based update propagation guarantees the propagation of all updates in the face of store migration, immigrant version vectors can be used. Whereas each regular version vector (native version vector) is associated with the update of one logical object, an immigrant version vector is associated with the migration of a native version vector. The concurrency control subsystem thus has two version management systems, one for native versions which track object updates, and one for immigrant versions, which track native version. Immigrant versions similarly have a knowledge vector, and stability of immigrant versions. For example, when an object o is locally migrated from store S_{S} to Sₜ on device d, a new immigrant version is created for o on d, recording the version of o that was migrated from S_{S}.

As part of the pull-based update propagation strategy, immigrant versions are requested that are above the immigrant knowledge vector. If a received immigrant version was previously unknown to the local device, then the native version tracked by the immigrant version is persisted in the local device's native version table. The immigrant version subsystem can thus insert native versions under the native knowledge vector, but no native versions are at risk of loss because of cross-store object migration.

Team Server: Multiple User Accounts on One Device

In yet another alternative, for a team of users who wish to use a shared device to back up their files, the system provides a Team Server type account which permits multiple stores from multiple users on the same device. This Team Server account would be among those in the Access Control Lists (ACLs) for all stores shared by the team members, including the root store for all team member users. The Team Server account is concerned with stores, and thus need only synchronize one copy of a store as it is shared by multiple users. Whereas the support of file migration across stores for a single-user device necessitates the invariant that an object id can be admitted in only one store on a device, on a Team Server, an object id may be admitted in multiple stores, because Team Servers are not concerned with migration.

One source of backup is often insufficient, thus the system offers a self-replicating server farm, via multiple Team Servers. In one embodiment, one Team Server account is installed on n devices, and the processes discussed above synchronize the files and folders of those servers, providing a replication factor of n. In another embodiment, multiple devices are installed with the same account, but each device stores a partition of the total team space requirements, permitting a scalable replication factor from 1 to n (e.g., Selective Syncing, by setting the “expelled” flag on some devices).

Collaborative Version History

Whenever a remote file update is downloaded (including modifications and deletions), the local copy of the file is saved to a special location, creating a local version history for every file. Through a GUI display, users can restore files from this version history. The version history is truncated after some time period.

One can also consider the global version history for a file in the distributed system of devices, which includes these local saves across all devices. In another embodiment, each version history file is tagged with its corresponding version vector, and the user id and device id which instigated the update. Users can visualize the system aggregate version history tree, and if a desired file version is not locally present, the device can request that version from the device that performed the backup. When requesting remote version history, the local device can avoid presenting duplicate version history items by detecting duplicate version vectors.

Sync Status

To inform users whether a file on their local device has been synchronized with other devices, the system provides a method to determine the sync status of each file and folder by comparing version vectors across multiple devices. In one embodiment, given an object and two devices sharing it, the method reports whether both devices have the same version or a different version. The sync status is recorded as a set of devices that are in or out of sync with the local device. To show meaningful status for a directory, the sync status is recursively aggregated from all descendent files and folders. Via a file-system GUI icon overlay, three possible sync status states are presented to the user for each file or folder:
in-sync: all devices are in sync
partial sync: at least one device is in sync and at least one is out of sync
out of sync: all devices are out of sync

In one embodiment, the method takes a centralized structure where a single server stores the hash of the current version vector of every object for every device. On update, these version vectors are broadcasted to those client devices interested in the given object, ensuring the Sync Statuses remain up-to-date. In another embodiment, a decentralized structure is employed, where client devices record the version vector of every object and every device, or some partition of that data.

In the description above, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

What is claimed is:

1. A non-transitory computer-readable medium having stored thereon a plurality of instructions for collecting updates for a plurality of objects over a cloud data network, the instructions, when executed by a processor, causing the processor to perform:
determining a set of remote devices known to have updates for a selected object, wherein each of said remote devices maintains a set of locally updated objects that includes the selected object; and
downloading the updates for the selected object from said set of remote devices over the data network.

2. The computer-readable medium of claim 1, wherein said set of locally updated objects is represented as Bloom filters.

3. The computer-readable medium of claim 1, wherein said set of locally updated objects is maintained as a queue having a minimum number of updated objects, an end number of updated objects, and a current object to be collected at a head of the queue.

4. The computer-readable medium of claim 3, further comprising inserting a new updated object into said set of locally updated objects following the end number of updated objects that is independent of the current object to be collected.

5. The computer-readable medium of claim 1, further comprising deleting said selected object, wherein said selected object includes an expelled label and said downloading the updates includes unsynchronizing said plurality of objects having an expelled label.

6. The computer-readable medium of claim 1, wherein said downloading the updates for the selected object results in a name conflict that occurs when said selected object is referenced using a logical name, wherein an existing object that is different than said selected object is referenced using said logical name.

7. The computer-readable medium of claim 6, further comprising resolving said name conflict, wherein said resolving includes:
designating one of said selected object and said existing object as a target;
assigning the undesignated object as an alias having a pointer relationship to the target; and
merging all meta-data of the alias object into the target.

8. The computer-readable medium of claim 6, wherein said resolving a name conflict comprises modeling said selected object with said logical name and said existing object with said logical name as states having transitions between the states.

9. A computer-implemented method for collecting updates for a plurality of objects over a cloud data network comprising:
determining a set of remote devices known to have updates for a selected object, wherein each of said remote devices maintains a set of locally updated objects that includes the selected object; and
downloading the updates for the selected object from said set of remote devices over the data network.

10. The computer-implemented method of claim 9, wherein said set of locally updated objects is represented as Bloom filters.

11. The computer-implemented method of claim 9, wherein said set of locally updated objects is maintained as a queue having a minimum number of updated objects, an end number of updated objects, and a current object to be collected at a head of the queue.

12. The computer-implemented method of claim 11, further comprising inserting a new updated object into said set of locally updated objects following the end number of updated objects that is independent of the current object to be collected.

13. The computer-implemented method of claim 9, further comprising deleting said selected object, wherein said selected object includes an expelled label and said downloading the updates includes unsynchronizing said plurality of objects having an expelled label.

14. The computer-implemented method of claim 9, wherein said downloading the updates for the selected object results in a name conflict that occurs when said selected object is referenced using a logical name, wherein an existing object that is different than said selected object is referenced using said logical name.

15. The computer-implemented method of claim 14, further comprising resolving said name conflict, wherein said resolving includes:
designating one of said selected object and said existing object as a target;
assigning the undesignated object as an alias having a pointer relationship to the target; and
merging all meta-data of the alias object into the target.

16. The computer-implemented method of claim 14, wherein said resolving a name conflict comprises modeling said selected object with said logical name and said existing object with said logical name as states having transitions between the states.

17. A non-transitory computer-readable medium having stored thereon a plurality of instructions for resolving a name conflict between a first object and a second object being different than the first object, both of said first object and said second object being referenced by a logical name, the instructions, when executed by a processor, causing the processor to perform:
designating one of said selected object and said existing object as a target;
assigning the undesignated object as an alias having a pointer relationship to the target; and
merging all meta-data of the alias object into the target.

18. A computer-implemented method for resolving a name conflict between a first object and a second object being different than the first object, both of said first object and said second object being referenced by a logical name comprising:
designating one of said selected object and said existing object as a target;
assigning the undesignated object as an alias having a pointer relationship to the target; and
merging all meta-data of the alias object into the target.
